(19) United States
(12) Patent Application Publication
(10) Pub. No.: US 2026/0178464 A1
(43) Pub. Date: Jun. 25, 2026

(54) SYSTEM AND METHOD OF SOFTWARE BEHAVIOR ANALYSIS

(71) Applicant: CODIUM LTD., Ramat-Gan (IL)

(72) Inventors: Gadi ZIMERMAN, Hod-Hasharon (IL); Itamar FRIEDMAN, Ramat Gan (IL); Shai GEVA, Tel Aviv-Yafo (IL)

(73) Assignee: CODIUM LTD., Ramat-Gan (IL)

(21) Appl. No.: 19/126,487

(22) PCT Filed: Nov. 2, 2023
(86) PCT No.: PCT/IL2023/051131

§ 371 Date: May 1, 2025

Related U.S. Application Data
(60) Provisional application No. 63/382,270, filed on Nov. 3, 2022.

(51) Int. Cl. G06F 11/3604; G06F 11/3668; G06F 40/186; G06N 20/00

(52) U.S. Cl. CPC G06F 11/3604; G06F 11/3684; G06F 40/186; G06N 20/00

(57) ABSTRACT

There are provided a method and a system of software behavior analysis. The method comprises: retrieving data sources related to a software program and mapping a list of behaviors characterizing the software program. Additionally, the method can comprise analyzing the list of behaviors to obtain at least one trait of at least one of the behaviors, and/or transcoding the list of behaviors to corresponding natural language descriptions and presenting the natural language descriptions of the list of behaviors to a user on a Graphical user interface (GUI). There are further provided a method and a system of testing changes between different versions of a software program based on the software behavior mapping and analysis.

### TECHNICAL FIELD

The presently disclosed subject matter relates, in general, to the field of software behavior analysis, and more specifically, to the field of software behavior mapping and validation.

### BACKGROUND

One of the attributes of high quality software code is that the code “behaves” in a substantially identical manner to how it was intended to behave (i.e., the design of the software). Whenever there is a gap between the designed behavior and the actual behavior, this discrepancy may be considered as a software implementation “bug” that needs to be amended.

Ideally, it is preferred to have, on the one hand, a detailed description of what the software product intends to do (e.g., in a free text or structured natural language description), and, on the other hand, a detailed description of what the actual software implementation does, which are then compared. However, the current situation is far from being so. By way of example, product requirements are usually not in place or lack details, and software behaviors or properties are not mapped as a standard. Furthermore, currently, software properties are not converted to natural language descriptions. Software properties refer to general software behavioral rules, which are sometimes mapped using property-based tests, as opposed to behavioral examples which are sometimes mapped using example-based tests. In example-based testing, a specific sample of the code behavior is tested. For example, for a specific input V of function F, it is asserted that a specific output O should be received. In property-based testing, the general behavior of the code is tested. For example, for any input V of function F, the output O behaves in a certain way, e.g., O>V or size(O) equals size(V).

Currently, one leading industry standard to validate software behavior relates to tests that sample the expected behavior for a particular software module (unit tests, module tests, integration tests, etc.). These tests, for the most part, are manually coded by the developer who wrote the code to be tested. Manually written tests have several downsides:
1. Quality of test code fluctuates between different developers, depending on their mood, devotion, and/or prioritization to test writing.
2. While test writing is relatively mundane work, it is significantly time-consuming for the professional developer, causing software projects' budgets to increase.
3. Systematically mapping complex code behaviors is a challenging task for developers. Usually, there is a high degree of correlation between what is sampled in the test, to what has been coded, so tests usually miss un-intended behaviors.
4. Example-based tests are merely unique sampling of an expected behavior (and not a property of the behavior), making them very prone to break. They are also a sparse representation of the code behavior.

Another drawback of the software world is that, unlike the ideal case where all software projects are developed with clear, precise, and documented specifications, projects are rarely accompanied by such specifications. Due to hard deadlines and ‘short-time-to-market’ requirements, software products often come with poor and incomplete specifications, and in some cases even without any documented specifications. Even when projects are accompanied by specifications, as the software evolves, the documented specification is often not updated. This might render the original documented specification of little use after several cycles of program evolution.

### SUMMARY

In accordance with certain aspects of the presently disclosed subject matter, there is provided a computerized method of software behavior analysis, the method comprising: retrieving data sources related to a software program; mapping a list of behaviors characterizing the software program; and analyzing the list of behaviors to obtain at least one trait of at least one of the behaviors.

In accordance with certain aspects of the presently disclosed subject matter, there is provided a computerized method of software behavior analysis, the method comprising: retrieving input data from one or more data sources related to a software program; mapping a list of behaviors characterizing the software program based on the input data; and transcoding the list of behaviors to corresponding natural language description (NLD) and presenting the NLD to a user on a graphic user interface (GUI).

In addition to the above features, the method according to this aspect of the presently disclosed subject matter can comprise one or more of features (i) to (xxiii) listed below, in any desired combination or permutation which is technically possible:
(i). The data sources are retrieved in response to an invocation by at least one of: an event of code completion, an event of code modification, an event of manual invocation by a client terminal, an event of source control action, and an event of integrated development environment (IDE) action.
(ii). Each behavior in the list is an internal behavior or external behavior which is property-based or example-based.
(iii). The data sources comprise at least one of: inputs and outputs of a sequence of actions in the software program, software documentation, data statically extracted from the source code, and runtime data collected during execution of the software program and representative of internal workings of the software program.
(iv). The list of behaviors can be analyzed to obtain at least one trait of at least one of the behaviors.
(v). The at least one trait can be selected from a group comprising: estimated correctness, and code coverage of the behaviors. It is to be noted that the present disclosure is not limited to the two exemplary traits, and any other traits that characterize the behaviors and provide additional information can be added to the group.
(vi). The transcoding can be performed by using a machine learning (ML) model capable of learning relationships between the list of behaviors and corresponding natural language description in order to convert therebetween.
(vii). The transcoding can be performed by using a series of ML models that are, respectively or in combination, configured to perform at least some of the following: classifying behaviors to one or more types, selecting templates that are closely related to the one or more types, and filling in the templates, thereby resulting in the natural language description(s).
(viii). The transcoding can comprise obtaining a dataset comprising a plurality of samples, each sample represented by a tuple constituted by code, code behavior, and NLD of the code; providing an input comprising source code of the software program from the input data, and the list of behaviors, and searching in the dataset for one or more candidate samples based on a similarity metric between the input, and the code and the code behavior of the tuple of each sample in the plurality of samples; and using the one or more candidate samples as templates for generating the NLD of the list of behaviors using a large language model (LLM).
(ix). The using one or more candidate samples can comprise providing the one or more candidate samples as input examples to the LLM to enable the LLM to learn from the input examples using in-context learning (ICL), thereby obtaining, as output of the LLM, the NLD of the list of behaviors.
(x). The using one or more candidate samples can comprise extracting a NLD template from the one or more candidate samples and using the LLM to fill the NLD template, thereby obtaining the NLD of the list of behaviors.
(xi). The NLD template can be represented as a text placeholder characterized by one or more parameters extracted from the one or more candidate samples.
(xii). The NLD can include a visual representation of a diagram representing an architecture of a corresponding behavior in the list of behaviors.
(xiii). The method further comprises manipulating the list of behaviors by at least one of: filtering, ordering and grouping the list of behaviors.
(xiv). The manipulation comprises: consolidating the list of behaviors to a group of high-level behaviors based on the at least one trait, wherein each high-level behavior is associated with its subsidiary behaviors, and presenting the natural language descriptions of each high-level behavior and subsidiary behaviors associated therewith on the GUI in a hierarchical view.
(xv). The method further comprises enabling the user to manipulate at least part of the natural language descriptions including at least one of the following: accepting, rejecting, adding, or amending a natural language description of a desired behavior, thereby indicating a portion in source code of the software program that needs to be adjusted accordingly.
(xvi). The method further comprises inspecting the one or more behaviors with respect to one or more designed behaviors to verify original intent thereof.
(xvii). The method further comprises automatically generating one or more tests for each behavior from a subset of behaviors selected from the list of behaviors.
(xviii). The subset of behaviors is selected based on the at least one trait or the user's decision.
(xix). The one or more tests are property-based or example-based.
(xx). The generating comprises searching for a minimal representation of the tests for the at least one behavior.
(xxi). The retrieving and mapping are performed for a first version of the software program and a second version of the software program, giving rise to a first list of behaviors and a second list of behaviors. The method further comprises comparing the first and second lists of behaviors for validating changes between software versions.
(xxii). The first and second lists of behaviors are transcoded into corresponding first and second natural language descriptions, wherein the comparing comprises comparing the first and second natural language descriptions.
(xxiii). The comparison of the first and second natural language descriptions uses a machine learning model capable of performing matching and scoring matches of natural language descriptions.

In accordance with certain aspects of the presently disclosed subject matter, there is provided a computerized method of testing changes between different versions of a software program, comprising: retrieving a first version and a second version of the software program; mapping a first list of behaviors characterizing the first version and a second list of behaviors characterizing the second version; comparing the first list and second list of behaviors to identify one or more behaviors that have changed between the first and second versions; and presenting to a user the one or more behaviors, thereby allowing the user to decide whether to accept, reject, or fix the one or more behaviors.

These aspects of the disclosed subject matter can comprise one or more of features (i) to (xxiii) listed above, mutatis mutandis, in any desired combination or permutation which is technically possible.

In accordance with certain aspects of the presently disclosed subject matter, there is provided a computerized system of software behavior analysis, the system comprising a processing and memory circuitry (PMC) configured to perform any operations as described above with respect to the method aspects.

In accordance with other aspects of the presently disclosed subject matter, there is provided a non-transitory computer readable medium comprising instructions that, when executed by a computer, cause the computer to perform any operations as described above with respect to the method aspects.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of software behavior mapping, analysis, and UI in accordance with certain embodiments of the presently disclosed subject matter.

FIG. 2 illustrates a generalized and exemplary flowchart of software behavior mapping and analysis in accordance with certain embodiments of the presently disclosed subject matter,

FIG. 3 illustrates an exemplary user interface (UD) of an application of software behavior mapping and analysis in accordance with certain embodiments of the presently disclosed subject matter.

FIG. 4 illustrates a generalized block diagram of software version comparison using software behavior mapping and analysis in accordance with certain embodiments of the presently disclosed subject matter.

### DETAILED DESCRIPTION OF EMBODIMENTS

In the following detailed description, numerous specific details are set forth in order to provide a thorough understanding of the disclosure. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “retrieving”, “mapping”, “analyzing”, “invocating”, “transcoding”, “presenting”, “learning”, “performing”, “classifying”, “selecting”, “filling”, “adjusting”, “manipulating”, “filtering”, “ordering”, “grouping”, “consolidating”, “enabling”, “inspecting”, “generating”, “searching”, “comparing”, “validating”, “matching”, “scoring”, “searching”, “using”, “providing”, “extracting”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the software analysis system, the ML model(s) utilized thereof, and respective parts thereof disclosed in the present application.

Embodiments of the presently disclosed subject matter are not described with reference to any particular programming language. It will be appreciated that a variety of programming languages may be used to implement the teachings of the presently disclosed subject matter as described herein.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases”, or variants thereof, does not necessarily refer to the same embodiment(s).

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

In embodiments of the presently disclosed subject matter, one or more stages illustrated in the figures may be executed in a different order, and/or one or more groups of stages may be executed simultaneously, and vice versa.

There is now provided a glossary of terms used herein which are defined for exemplary purposes in accordance with certain embodiments of the presently disclosed subject matter. The definitions should be expansively construed to cover any equivalents and/or permutations thereof.

System Under Test (SUT): The software (also referred to as product or software product) to be tested. SUT can refer to certain units/components of the software.

Behavior (also referred to as software behavior, or code behavior): referring to any characteristic of the software. Note that a behavior can be internal/external, and/or example-based/property-based, or any combination thereof, where:
External behavior refers to any behavior of the SUT that is externally observable. An example of external behavior can be a specific output of the software for a specific input or a sequence of inputs.
Internal behavior refers to any behavior of the SUT that is not externally observable. Examples of external behavior can be code coverage given a certain input, an exception that appears in a certain scenario, etc.
Example-based behavior refers to any behavior of the SUT that is associated with a specific input example (it can be either internal or external). Example-based behavior is contrasted with property-based behavior.
Property-based behavior refers to any behavior of the SUT that is related to general behavioral rules rather than a specific example (it can be either internal or external). An example of property-based behavior can be: if the income is in the range 1,000-1,500, no tax is owed. Properties are defined in more detail below.

There is now described one example for demonstrating the different types of behaviors. Assume a user interface illustrates the below:
Please enter a number: ______ [send button]
This is the squared number result: ______
A function associated with the above works as follows: it reads the input number, counts how many times this function is called (e.g., for various purposes, such as monetization reasons, or counting usage etc.), multiplies the input number by itself to get the square and returns it to the UI. The function can be exemplified in the below pseudo code:
Function example( )
   Number=read_input( )
   Db_counter=db_counter+1
   Output=number*number
   Display (Output) In the present case, an example-based external behavior can be that when the input is 3, the output is 9. An example based internal behavior can be that when an input of 3 is provided, the counter is updated with a value of one more than it used to be. A property-based external behavior can be that for any input, the output provided would be the square of that input. A property-based internal behavior can be that for any input, the counter is updated with a value of one more than it used to be.

Regression test/testing: aiming to verify that, when code changes, there are no unintended changes to the behavior of the software. This is the most common form of automated testing. A developer will typically write some automated tests that capture the current behavior of the SUT (which typically gets little or no value at the time of writing the test because there is a high correlation between the behavior the developer implemented and the behavior that the developer is testing). “Capturing behavior” here means that the SUT or part of it is executed (possibly with some limitations), and the behavior (such as the output) is observed and compared to the expected behavior. The tests pass if the tested condition is true, and fail if it is not true. When the code changes at a later time, any such test will either pass, giving some confidence that the captured behavior has not changed, or it will fail, signaling that the captured behavior has changed and forcing the developer to either change the test if the behavior change is correct, or fix the behavior if the change is incorrect.

Code coverage: an industry term describing which parts of the code were executed by running the SUT, as part of an automated test(s), with some input/pool of inputs. There are several distinct variants of code coverage (such as code line coverage, and code branch coverage, etc.). Code coverage is used to evaluate the quality of a test suite, where a test suite that has relatively higher code coverage is commonly considered better because it exercises a larger part of the code, increasing the likelihood that if an error is introduced to the code, it will result in a failure of one of the tests.

Mutation testing: a method of evaluating the quality of a test suite, similar to code coverage, where:
Code mutation: a change to the code of the SUT, such as removing a line, replacing a calculated expression with a constant value, causing an exception instead of continuing the normal flow, returning instead of continuing the normal flow, replacing a used variable in some expression with a different variable.
Code mutant: a version of the SUT which includes a code mutation.
Mutation testing process: multiple mutants of the SUT are created, and each one bas the test suite executed for it. If any of the tests pass the SUT, but fail on the mutant, it is said that this test (and the test suite) kills the mutant. A test suite that kills a large percentage of mutants is considered higher quality than a test suite that kills a small percentage of mutants.

Data sources (also referred to as datapoints): Information collected about the SUT, including, for example, one or more of the following: the inputs and outputs of a sequence of calls to the system; software documentation; data statically extracted from the source code (statically-by examining the code text files, without running the code), such as function signatures; and runtime data (or runtime instrumentation data), such as observation collected about the internal workings of the code, such as, e.g., values that a variable inside a function contained when running the SUT with certain input.

Property (also referred to as software/code property): a behavioral rule of the software that is more general than a specific example. Examples of properties include: “a sorted list is ordered from smallest to largest”, “if socket.bind( ) is not called before calling socket.listen( ), then socket.listen( ) will throw an exception”, and “when calling the SUT with input in the range of 10-15, the execution flow goes through a specific line”, etc. Properties might describe external code behavior or internal code behavior (also referred to as “external properties” or “internal properties”).

Behavior mapping refers to an automated process that extracts behaviors for a given software. Behavior mapping can use a variety of methods, e.g., by static analysis (analyzing code without running it) and/or dynamic analysis (running code, invoking it with actions or sequences of actions, and observing the code's behavior). Behavior mapping can relate to behaviors based on individual examples (such as a specific input and its corresponding output) as well as behaviors based on more general code properties (as defined above). Behavior mapping can map both internal and external behaviors.

Fuzzing refers to a technique that uses generated random (or semi-random) data as input to an SUT in order to exercise a large portion of the SUT's functionality.

Property-based testing refers to a testing technique that uses fuzzing or relatively large datasets to generate inputs for an SUT, while verifying properties on the SUT. A property in this context is similar to a code property as defined above, and it can be formalized as an executable Boolean condition (like “return_value<parameter+3”). Property-based testing can then create many inputs using fuzzing and verify properties on the outputs of the SUT.

Property-based testing has the advantage that it verifies that a property is correct for any random input, as opposed to example-based testing that only verifies correctness for specific inputs. However, property-based testing is useful in use cases where such properties are known and can be phrased/formulated, and it can only verify these properties, which is not always a strong guarantee of correctness as verifying a specific expected output. For example, the property “a sorted list is ordered from smallest to largest” is true for any input for a buggy “sorting function” that always returns the list [1, 2].

Shrinking: commonly associated with property-based testing, shrinking is a technique that finds a minimal input for which a property is correct (or incorrect). For example, consider a sorting function with a bug in it: the function always returns the same list [2, 7], irrespective of the input. Consider a property-based test that checks the property that the output of the sorting function contains the same elements of the input list. The property would be violated for almost all input lists. For example, for different input lists such as [1, 2], [4, 4, 7], etc., the output of the sorting function would always be [2, 7]. A minimal example might be the list [0], because it is a very small and simple list, and the property is already incorrect for it.

Coverage-guided fuzzing refers to a technique to perform fuzzing, where code coverage information such as which lines of code have been visited when invoking the SUT with some input (i.e., line coverage), is utilized to help choose other inputs for invoking the system, in a way that, among other objectives, adds inputs to the input pool, such that all inputs in the pool, when combined, have good code coverage.

Software documentation refers to any documented information that is intended to provide additional information about the software, such as, for example: company specification documents, software package home website, tutorial videos etc. In some cases, software documentation can include informal software documentation, which may not be in an intentional structured format, such as, e.g., transcripts of meetings discussing the software, messages between developers and product managers working on the software, social media posts mentioning the software, etc.

In order to mitigate the software industry drawbacks as described above, methods that try to map code behaviors have emerged. The term “code behavior” or “software behavior” encompasses basically any characteristic about the code and what it does. For example, it can include one or more of the following: (a) the expected output for a specific input, (b) a general connection between inputs and outputs (termed “property‘), (c) running times of that piece of code, (d) a connection between inputs and code coverage, etc. Some of these methods of behavior mapping are in some cases termed ‘specification mining’. However, the term “specification mining” usually refers to externally measurable behaviors excluding internal behaviors, whereas behavior mapping refers to mapping of one or more of the internal and external behaviors, and/or example-based and property-based behaviors. By way of example, some of the behavior mapping methods may try to analyze the code (directly or indirectly) and automatically create behaviors that describe the module. The created behaviors allow the developers to validate that the code behaves as expected. The same term ‘properties’, when being used in “property-based testing (PBT)”, describes a type of testing. In PBT, the developer can write tests that are more than just samples/examples of the behavior (termed example-based testing), and constitute rules that can be used to create a template that can be used to generate many tests. When behavior mapping can automatically produce a set of behaviors, naturally, corresponding example/property-based tests can automatically be generated as well. However, behavior mapping per se does not require converting to natural language.

Hence, given the advantages of behavior mapping, and the mentioned challenges, behavior mapping can be regarded as a promising alternative or prerequisite to software testing (the current method of choice for software quality assurance). The following describes how behavior mapping may help mitigate the aforementioned caveats: 1. automatically generating code behaviors and corresponding tests, which will no longer be dependent on developers' goodwill and capabilities; 2. software developers will focus on professional tasks and not testing, decreasing software projects' budgets; 3. the tests that will be created are significantly more thorough; 4. tests will be generalized, thus becoming more robust to changes and implementation details; and lastly, 5. at any given time, a specification document can be generated for any code.

Certain methods for computerized behavior mapping can be based on inductive learning. That is, for example, making observations about software and inductively generalizing the observations into behaviors. A limitation of pure inductive-learning-based behavior mapping methods may be that they are often biased towards complying with the specific obtained observations which could be insufficient and limited. Computerized behavior mapping, using machine reasoning or inductive reasoning, has been unsound for decades, but has started to show great progress due to advances in machine learning algorithms such as, e.g., the Transformers and Large Language Models (LLMs), as well as growing open and inner source repositories that could be used in the learning processes. Despite these advances, it still remains a great challenge (both technically and process-wise) to map and manage code behaviors.

There are now provided some examples of behavior mapping according to certain embodiments of the present disclosure. The mapped behaviors can describe a variety of relations, such as (a) a relation between the input (or part of the input) of the SUT (e.g. a function) to the output (or part of the output) of the SUT, (b) a relation between the input (or part of the input) of the sub-SUT (e.g. a method within a class) to the output (or part of the output) of another sub-SUT, (c) a relation between the input (or part of the input) and the executed branch (code line coverage) (d) etc.

In some cases, the system can analyze inputs and outputs of sequences of actions to discover behaviors such as properties. For example, by analyzing datapoints from two sequences which are identical except for a single change of input, the system can observe whether any outputs have changed, thus deducing a property that describes the connection between two different actions on the SUT (such as “if you change the data of create_tweet( ), then the return value of get_tweet( ) would be different.”).

The system can, for example, analyze and compare inputs and outputs of an individual action on the SUT, thus deducing a property that describes how parts of the input affect parts of the output (such as “all tags in the list of tags in create_blog_post( ) will be part of the list retrieved by get_blog_post_tags( )”).

The system can, for example, analyze runtime data associated with a sequence of actions on the SUT, examining code line coverage information, thus deducting a property that describes that a sequence of actions represents a distinct behavior of the system, since it triggers a specific code line.

The system can, for example, analyze runtime data associated with a sequence of actions on a mutant of the SUT.

The system can detect whether for some specific input (or a category of inputs such as range of numbers) or a sequence of inputs, the output of the SUT and mutant are different. If they are different, the fact that they are different for this input is considered an internal property of the code.

The system can also create properties that derive not only from datapoints, but also from other properties. For example, “in a Stack class, the ‘push( )’ action can affect the output of all following actions except other ‘push( )’ actions” (which is an aggregate of other properties of the form “the ‘push( )’ action might affect ‘pop( )’”, “the ‘push( )’action might affect ‘size( )’”).

Natural language description of behaviors can increase explainability of the code by allowing users to explore code behaviors. One example of code behavior can be, e.g., “if list.add(item)is called, then the result of list.size( ) increases by 1”. Behavior mapping makes it easier for developers, in particular new team members, to work on the code. It can also help developers increase code quality by surfacing internal behaviors that represent bad practices. Code explainability, as well as code changes explainability, can be improved by generating natural language descriptions of code behavior, as will be described below. In some cases, behavior mapping can help automatically generate code specification documentation on-demand.

Advanced AI models can be used to evaluate whether actual mapped behavior of SUT is as intended. User intent can be inferred from various sources, including but not limited to documentation, informal documentation, wisdom of the masses, and public sources, such as open-source repositories, etc. The correctness of intention can either be relative to inferred specific user intent (for example, a statement in a proprietary company specification document), or inferred generally plausible behavior (such as a behavior that is typical in open-source projects, not specific to the user's company). By way of example, the mapped behavior can be compared with the user intent as specified in the specification document to verify the original intent.

Some aspects of the interactions mentioned above, with the developers (but even more so with less technical code stakeholders) require natural language description. For example, natural language description may be required in order to review the behaviors, create an automatic software spec, and perform natural language-based comparison between extracted behavior and spec, etc. However, translating behaviors' data representation into human readable natural language can be a complex task due to the following reasons: (a) the richness of behaviors is infinite, so trying to use predetermined templates for natural language translation may be cumbersome and can support only a limited amount, and (b) it is hard to train a single standard neural network to translate between data structures representing behaviors and natural language description.

It is to be noted that natural language description referred to herein can be represented in any suitable type of visual representation, such as, e.g., text representation, diagram representation, software specifications, etc., where natural language is used for describing the behaviors.

According to certain embodiments, one way to realize the natural language translation can be by generating smart templates. In some embodiments, smart templates refer to one ML model, or a combination of ML models (such as, e.g., neural networks), that are configured to classify behaviors to their types, select templates that are closely related to those types, fill in the templates, and adjust the filled templates, thereby resulting in natural language description. This allows to close the gap that is not covered by the limited richness of the predetermined templates. Another way to achieve this is by using advanced machine learning models such as LLMs which are capable of learning complex relationships between behaviors that are represented by data structures and natural language description in order to convert between the two.

In some embodiments, smart templates refer to a method/system that facilitates the conversion/transcoding of code behaviors, whether simple or complex, into natural language descriptions (including a visual representation that includes natural language descriptions, such as, e.g., software specifications and architecture diagrams, etc.). Such a method/system may be implemented as follows:
1. Obtain a dataset (named D, e.g., a relatively large dataset) containing a plurality of samples (e.g., n high-quality samples), where each sample can be represented as a tuple constituted by code, code behavior and NLD of the code, such as, e.g., sample_n=(code_n, code's behaviors_n, natural language description of the code_n).
2. Given an input=(code_input, code's behavior_input), such as the source code of the software program which can be retrieved from the input data, and the list of behaviors as described in 202, search for one or more candidate samples based on a similarity metric between the input, and the code and the code behavior of the tuple of each sample in the plurality of samples, e.g., searching for the top T (e.g., T=5) most similar samples from dataset D according to a similarity between the given input and (code_n, code's behaviors_n) of the n samples in dataset D.
3. Use the one or more candidate samples (e.g., T samples), including their natural language description of the code, as templates for generating the natural language description of the list of behaviors using an LLM.

One possible technique to implement above step 3 is to use in-context learning, e.g., use the T samples as examples to inspire LLMs during inference. In-context learning (ICL) is a specific method of prompt engineering where demonstrations of the task are provided to the ML model (e.g., LLM, transformer, etc.) as part of the prompt. ICL learns a new task from a small set of examples presented within the context (the prompt) at inference time. In the present case, the top T samples can be provided to a LLM as input examples, to enable the LLM to learn from these examples using ICL, and provide as output of the LLM, natural language description for the list of behaviors.

Another possible technique to implement above step 3 is to extract NLD templates from the one or more candidate samples, and use the LLM to fill the NLD templates, thereby obtaining the NLD of the list of behaviors. For example, given that a chosen template includes the following natural language description:
“Function delete_user takes in user_id and returns (did_succeed, requires_action), which is utilized for the purpose of enabling to delete a user from the system and follow with required actions to complete the deletion process”, the LLM can identify the placeholder such as [FUNCTION_NAME], [PARAMETERS], [RETURN_TYPE], and [PURPOSE]. The extracted NLD template can be represented as a text placeholder characterized by one or more parameters extracted from the one or more candidate samples, such as follows:
“Function [FUNCTION_NAME] takes in [PARAMETERS] and returns [RETURN_TYPE], which is utilized for [PURPOSE]”

In some embodiments, a designated LLM with designated training can be created and trained to be used for the above system, including converting (code, code's behaviors) to natural language description, and converting natural language description into smart templates, etc.

In some cases, methods used to analyze and create code's behaviors from code can be specifically chosen to enable improved accuracy for LLMs used in other steps of the presently disclosed subject matter.

In some cases, the behaviors can be further analyzed. Behavior analysis may represent calculating additional traits of one or more of the following: (a) behaviors, (b) behaviors' natural language description, and/or (c) behaviors' corresponding generated tests. In some cases, the additional traits can be crucial for efficient interaction of the user with the system as they can serve as a recommendation system (potentially actionable) for different use cases. For example, a behavior trait may be a correctness score of a code behavior, indicating the level of correctness of the behavior with respect to the spec. A low score (e.g., relatively lower than a threshold) may indicate that the user needs to further inspect the relevant code. In an alternative use case, the behavior trait may be code coverage of the behavior's corresponding tests for testing a behavior, which can serve as a metric that the user can use in order to select/deselect tests for the test suite.

In some embodiments, mapping the code behaviors can allow (whether in data structure representation and/or in natural language description) to generate behavior-based tests or example-based tests. For example, assuming a code behavior P (in its natural language form) is “changing the value of the second variable V2 of function F always changes the first output O1 of function F”, a corresponding behavior-based test can be for example as follows:
test_P( )
   [O1_1, O2_1]=F(V1, V2, V3)
   [O1_2, O2_2]=F(V1, V2′, V3)
   assert O1_1 isn't equal to O1_2

That is to say, for any value of V1, V2, V2′, and V3, as long as V2′ is not equal to V2, it is demanded that the first output of F should be changed. Corresponding example-based testing can be, for instance, as follows:
test_P( )
   [O1_1, O2_1]=F(5, 5, 5)
   assert O1_1==125
   [O1_2, O2_2]=F(3, 4, 4)
   assert O1_2==48

In some cases, when creating behavior-based tests, the goal can be to create a minimal representation of tests, i.e., a test suite that reveals the behaviors in the most concise manner. The motivation behind this is two-fold. First, the conciseness allows the tests to be more human-readable, as well as easier to reproduce in a development environment. Second, machine learning models that receive this coincide test code as input, can perform better. However, creating such a minimal representation of tests is often not trivial. It requires taking real executable code from which the behavior was inferred, and searching for minimal representation (also termed shrinking, as defined above). Once a minimal representation is found, a further step of translating the data structure representation of the behavior into computer-readable language, such as computer code, is needed. This poses additional challenges similar to the ones mentioned in creating a natural language representation of the behaviors.

As described in certain embodiments of the present disclosure, mapping the behaviors of code modules and presenting the developer with the behaviors of the code modules in a natural language can provide a practical and plausible solution for developers to create a comprehensive software specification and tests, including, for example, to automatically create regression behavior comparisons (i.e., regression tests as defined above) based on natural language description of the behaviors. The comparison based on NLD of the behaviors can be achieved using LLMs.

Behavior gaps between expected behavior and the code's currently mapped behavior are known as system “bugs”. Mapping code behavior can be, therefore, regarded as a crucial step in locating those gaps. Usually, the comparison is done manually and may include a manual creation of a software specification described in natural and programming languages. Thus, a specification mining solution capable of comprehending and generating both natural and programming languages may be utilized to automate the process of mapping “buggy” behaviors.

Pre-trained large language models (LLMs) such as OpenAI Codex have shown immense potential in automating significant aspects of coding by producing code from informal natural language instructions or via instructions, including both programming language code and natural language instructions. However, the produced code does not have any correctness guarantees around satisfying users' intent. In fact, it is hard to define a notion of correctness since natural language can be ambiguous and lacks formal semantics. Certain solutions take a first step towards addressing the problem above by proposing the workflow of test-driven user-intent formalization (TDUIF), which leverages lightweight user feedback to jointly (a) formalize the user intent as example-based tests, and (b) generates code that meets the formal user intent. However, in a wide range of software development use cases, the following challenges still require an immense amount of manual work by developers and sometimes are pragmatically unfeasible: (1) comprehensively or continuously mapping code behaviors, (2) comparing actual code behaviors to the desired code behaviors, (3) expressing details or alerting on behavioral changes of software, or (4) a combination of the above, described in an easy-to-understand format, such as natural language with code samples.

In accordance with certain aspects of the presently disclosed subject matter, there is provided a computerized system of software behavior mapping, analysis, and UI, allowing its users (i.e., code stakeholders) to obtain, manage, and map code behaviors including a natural language description of the code behaviors enabling analysis and recommendation, such as those related to suspicious behaviors (potentially pointing at “bugs”).

The code stakeholders may be, for example, developers, development teams, and managers, as well as product managers.

The user interface may include, for example, a command line interface or a graphical user interface (GUD). The GUI may include, for example, a GUI for a web application or an integrated development environment (IDE) extension.

In addition to the above features, the presently disclosed subject matter can comprise one or more of the features listed below, in any desired combination or permutation which is technically possible:
(i). Optionally, the system can be further configured to allow users, through the dedicated UI, to inspect the mapping of code behaviors in a hierarchical view or any other behavior-mining-focused view. The hierarchical view can optionally be created when mapped behaviors can be consolidated together into high-level behaviors for more convenient data consumption. For example, instead of describing the following list of behaviors “A is affected by B”, “B is affected by B”, “C is affected by B”, and “D is not affected by B”, they may be consolidated to the following high-level behavior “Everything besides D is affected by B”. The hierarchical order may be obtained and manipulated in accordance with various behaviors' traits. As a way of example, these behaviors' traits may be analyzed directly (or via their natural language description) to produce a correctness score which can later be used to present the list of behaviors sorted by their correctness score.
(ii). Optionally, the system can be further configured to allow users, through the dedicated UI, to select a subset of code behaviors and generate behavior-based tests and/or example-based tests therefor, which correspond to a specifically selected subset of code behaviors.
(iii). Optionally, the system can be further configured to allow users, through the dedicated UI, to get a variety of code coverage and health metrics with corresponding gauges and alerts. These can be created by analyzing the code behaviors.
(iv). Optionally, the system can be further configured to allow users to get recommendations regarding whether it is a suspicious area of the code, or a non-suspicious area of the code (e.g., by the behavior analysis), so as to improve the code behavior to better fit the intent and/or best practices. The recommendation may include pointing out the location to improve, and, optionally, pointing out the recommended change in natural language or code.
(v). Optionally, the system can be further configured to allow users, through the dedicated UI, to review, reject, accept, add, or edit a code behavior description, and write an amended natural language description of the desired code behavior. These actions may be performed over a set of behaviors, one behavior, a subset of one or more behaviors, or behaviors' traits, which will result in pointing out to the user the location of the corresponding code section that needs to be amended accordingly, and, optionally, also the amended code.
(vi). Optionally, the system can be further configured to allow users to compare different versions of the code after the corresponding mapping of the different code versions' behaviors by comparing the natural language description of the codes' behaviors. This method may utilize machine learning models capable of performing matching and scoring matches of natural language code behavior descriptions, as described below in further detail.
(vii). Optionally, the system may be configured to match and compare mapped code behaviors to natural language descriptions in the code, code documentation, or other documents describing the desired software behavior, and alert when there is a discrepancy or a suspicious behavior detected in the code, in cases where a contradicting behavior is found in a relevant software description. This method may utilize machine learning models capable of performing matching and scoring matches of natural language code behavior descriptions, as described below in further detail.
(viii). Optionally, this system may utilize a machine learning multi-language model capable of performing matching and scoring matches of natural language code behavior descriptions to other natural language code behavior descriptions and the corresponding code written in a programming language.
(ix). Optionally, the system can be triggered to map entire code (each module at a time) or individual code modules, manually or automatically. Manual triggering by the user can be achieved, for example, by the user selecting a module and invoking the system. Automatic triggering can be achieved, for example, by recognizing relevant events such as, e.g., finishing or modifying the code module (in the version control), or by tracking the user IDE (e.g., finished writing a module, or detecting relevant keywords). Behavior mapping may occur for new code only, changed/modified code only, or the entire code.
(x). Optionally, the above may be performed iteratively, i.e., upon every interaction of the user with the UI, it is possible to trigger another iteration of the system to update the code behavior mapping, its corresponding natural language description, and analysis, etc.

In accordance with other aspects of the presently disclosed subject matter, there is provided a method of software behavior mapping and analysis to obtain a list of code behaviors, optionally including a natural language description of the code behaviors enabling analysis and recommendation, such as those related to suspicious behaviors.

In accordance with other aspects of the presently disclosed subject matter, there is provided a non-transitory computer-readable medium comprising instructions that, when executed by a computer, cause the computer to perform a method of software behavior mapping and analysis to obtain lists of the code behaviors including a natural language description of the code behaviors enabling analysis and recommendation, such as those related to suspicious behaviors.

These aspects of the disclosed subject matter can comprise one or more of features (i) to (x) listed above with respect to the system, mutatis mutandis, in any desired combination or permutation which is technically possible.

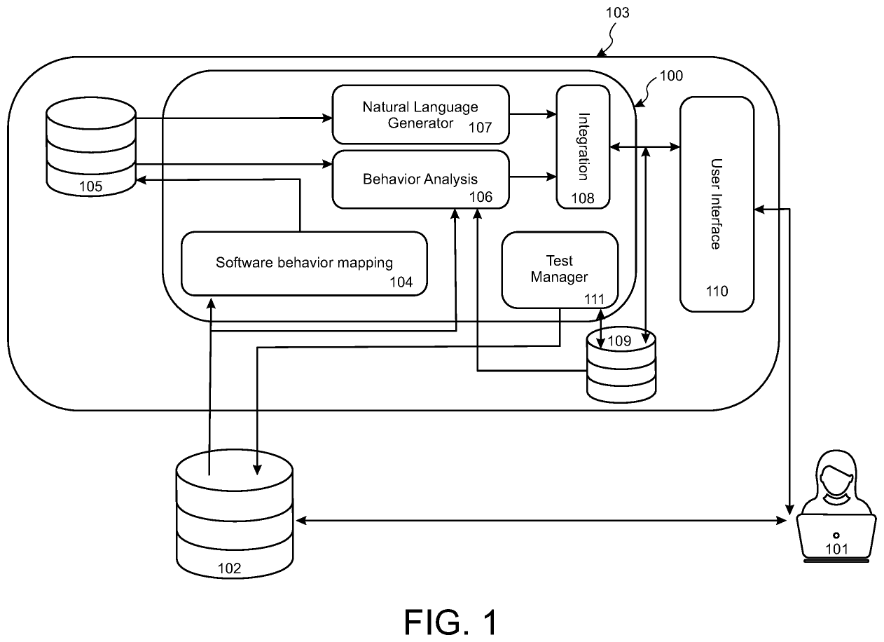

Referring now to the drawings, FIG. 1 illustrates a generalized block diagram of a system of software behavior mapping, analysis, and UI in accordance with certain embodiments of the presently disclosed subject matter.

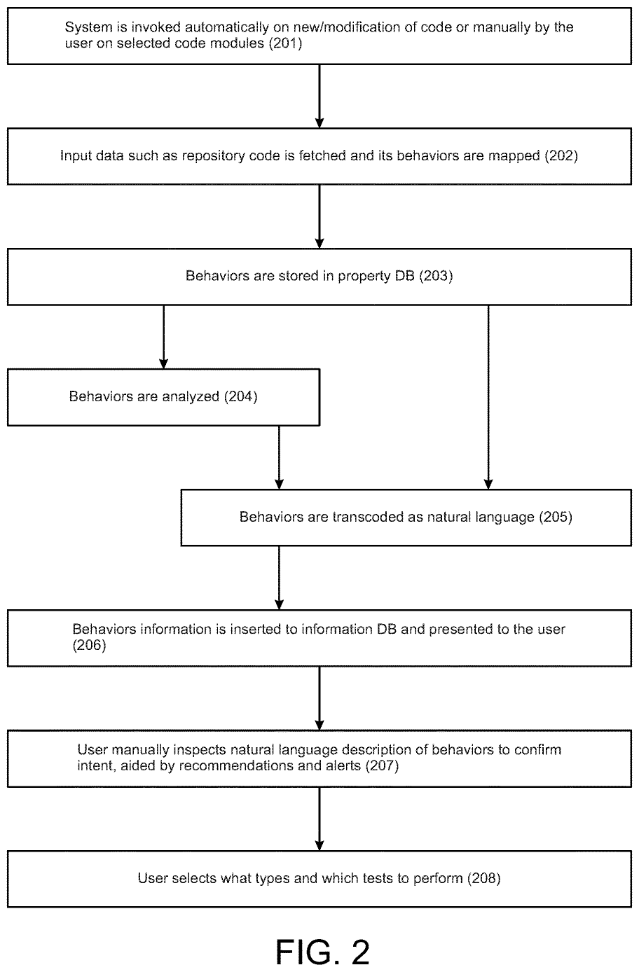

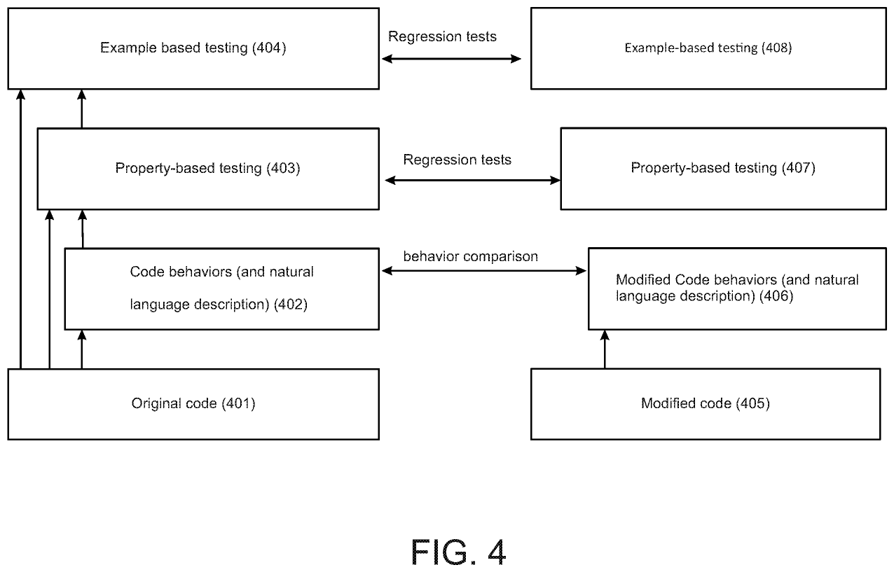

System 103 includes a processing circuitry 100 operatively connected to a user interface 110 and one or more databases (DBs), and configured to provide processing necessary for operating the system, as further detailed with reference to FIGS. 2 and 4. The processing circuitry 100 can comprise one or more processors (not shown separately) and one or more memories (not shown separately). The one or more processors of the processing circuitry 100 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

The one or more processors referred to herein can represent one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The functional modules comprised in the processing circuitry can include a Software Behavior Mapping module 104, a Behavior Analysis module 106, a Natural Language Generator 107, and optionally, a Tests Manager 111 and an Integration module 108, whose functionalities are described below in further detail.

The diagram in FIG. 1 illustrates one or more Client Terminals 101 of code stakeholders that are interested in software behavior mapping and analysis using System 103. Client Terminals 101 can represent distinct clients or teams working in coordination. Coordination means that one or more databases of System 103 can be shared between the users, so that any Client Terminals 101 that log into the system can share the same synchronized view. For example, if user A has disabled Test T, user B will be able to see that Test T was disabled, either in his next login or instantly if he is already logged in. Client Terminals 101 can connect to one or more client Code Repositories 102 which reside locally or remotely. The operations of System 103 can be manually triggered by Client Terminals 101, or automatically by detecting changes in Code Repositories 102, or by detecting changes in the IDE editor of Client Terminals 101. Whenever System 103 is triggered to operate on Code Repositories' 102 modules, as a whole or on a specific module, System 103 can map the code behaviors, directly and indirectly, using Software Behavior Mapping module 104, and store the mapped code behaviors in Property DB 105.

Optionally, behaviors can then be analyzed by Behavior Analysis module 106, with or without the inclusion of the original code, and with or without the inclusion of data from information DB 109 (which stores the natural language description of the behaviors and/or the corresponding tests), to provide one or more traits thereof. Behaviors undergo a transcoding process in order to generate a corresponding description of the behavior in natural language, which is performed by the Natural Language Generator 107. The information that is gathered, such as the traits from Behavior Analysis module 106 and the natural language description from the Natural Language Generator 107, is processed and aggregated by the Integration module 108 (e.g., a backend module) and stored in the Information DB 109.

The Information DB 109 provides all the needed information to interact with Client Terminals 101 via User Interface module 110 (in a UI such as a graphical user interface, command line, or other). Such user-facing information can include a natural-language description of the behaviors, and traits such as correctness scores, alerts, recommendations, etc. The Information DB 109 also provides all the needed information to generate tests via the Test Manager module 111. In some cases, the generated tests can form part of the repository's information and hence can be stored in the information DB 109 as well. The generated tests are also, optionally, part of a continuous integration/deployment (CI/CD) process and hence can be a part of the Code Repository 102. The Tests Manager module 111 generates, as well as manages, the example-based or behavior-based tests (e.g., it can be configured to prevent duplication of tests, create optimization of tests suite to maximize code quality while lowering total computation, etc.). In some cases, Client Terminals 101 can interact with the information stored in the information DB 109 (via Integration module 108) to fetch more information and/or make modifications to the test suite.

The process executed by the Tests Manager 111 may be automated and/or iterative, leveraging mutation testing, and test case shrinking which can be governed by the Behavior Analysis module 106 to create a trait-guided process, such as a coverage-guide process. The mutation testing may include code mutations, test data mutations, or both. The code mutation may include mutations in the code retrieved from the code repositories 102. These mutations are further selected in order to identify meaningful test cases. The code mutation selection may be derived from suggestions created using LLMs. These LLMs, by way of example, could be trained to suggest mutations that are useful for identifying meaningful test cases.

In some cases, additionally or alternatively, test data mutation may be selected to increase code behavior coverage. Test data mutation may be selected in accordance with suggestions created using LLMs. These LLMs, by way of example, could be trained to suggest data mutations that are useful for increasing code behavior coverage or useful to surface certain types of behaviors. Information to be provided to LLMs creating either code mutations and/or test data mutation can be passed as part of the model inferencing (also referred to as prompt engineering). Such information may include instructions related to a certain specification, e.g., in order to create behavior analysis or test data related to a certain specification.

The suggested system and UI can provide the user with a natural language description of the code behaviors, as well as traits such as code coverage metrics, correctness scores, alerts, and recommendations, etc. This may be used as an iterative process, where the system and the user are interacting with each other in order to increase the software product's value, for example, to complete the behavior mapping if some behaviors are missing, and/or choose the most relevant tests in order to optimize a code coverage metric. Users can also use the natural language description to help to search, filter, and explore behaviors.

According to certain embodiments, the various ML based modules referred to herein can be implemented as various types of machine learning models, such as, e.g., Support Vector Machine (SVM), Artificial Neural Network (ANN), regression model, Bayesian network, transformers, LLMs, etc., or ensembles/combinations thereof. The learning algorithm used by the ML model can be any of the following: supervised learning, unsupervised learning, self-supervised, or semi-supervised learning, etc. The presently disclosed subject matter is not limited to the specific type of ML model or the specific type of learning algorithm used by the ML model.

In some embodiments, at least some of the ML based modules can be implemented as a deep neural network (DNN). DNN can comprise multiple layers organized in accordance with respective DNN architecture. By way of non-limiting example, the layers of DNN can be organized in accordance with Convolutional Neural Network (CNN) architecture, Recurrent Neural Network architecture, Recursive Neural Networks architecture, Generative Adversarial Network (GAN) architecture, or otherwise. Optionally, at least some of the layers can be organized into a plurality of DNN sub-networks. Each layer of DNN can include multiple basic computational elements (CE) typically referred to in the art as dimensions, neurons, or nodes.

The weighting and/or threshold values associated with the CEs of a deep neural network and the connections thereof can be initially selected prior to training, and can be further iteratively adjusted or modified during training to achieve an optimal set of weighting and/or threshold values in a trained DNN. After each iteration, a difference can be determined between the actual output produced by the DNN module and the target output associated with the respective training set of data. The difference can be referred to as an error value. Training can be determined to be complete when a loss/cost function indicative of the error value is less than a predetermined value, or when a limited change in performance between iterations is achieved. A set of input data used to adjust the weights/thresholds of a deep neural network is referred to as a training set.

It is noted that the teachings of the presently disclosed subject matter are not bound by specific architecture of the ML model or DNN as described above.

It is to be noted that while certain embodiments of the present disclosure refer to the processing circuitry 100 being configured to perform the above recited operations, the functionalities/operations of the aforementioned functional modules can be performed by the one or more processors in processing circuitry 100 in various ways. By way of example, the operations of each functional module can be performed by a specific processor, or by a combination of processors. The operations of the various functional modules, such as, e.g., behavior mapping, further analysis, and natural language translation, etc., can thus be performed by respective processors (or processor combinations) in the processing circuitry 100, while, optionally, these operations may be performed by the same processor. The present disclosure should not be limited to being construed as one single processor always performing all the operations.

Those versed in the art will readily appreciate that the teachings of the presently disclosed subject matter are not bound by the system illustrated in FIG. 1. Each system component and module in FIG. 1 can be made up of any combination of software, hardware and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions other than those shown in FIG. 1.

Each component in FIG. 1 may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

It should be noted that the system illustrated in FIG. 1 can be implemented in a distributed computing environment, in which one or more of the aforementioned components and functional modules shown in FIG. 1 can be distributed over several local and/or remote devices. By way of example, the processing circuitry 100 and the various DBs can be located in the same entity (in some cases hosted by the same device) or distributed over different entities. By way of another example, the various functional modules in processing circuitry 100 can be distributed over different entities. In some cases, the training systems for training the ML models used in system 103 can be located in the same entity as the inference system 103, or distributed over different entities, depending on specific system configurations and implementation needs.

In some examples, certain components utilize a cloud implementation, e.g., implemented in a private or public cloud. Communication between the various components of the examination system, in cases where they are not located entirely in one location or in one physical entity, can be realized by any signaling system or communication components, modules, protocols, software languages, and drive signals, and can be wired and/or wireless, as appropriate.

FIG. 2 is a generalized and exemplary flowchart of software behavior mapping and analysis in accordance with certain embodiments of the presently disclosed subject matter.

First, as shown in a preliminary step illustrated in block 201, in some cases, system 103 can be automatically triggered, e.g., by an event of code completion, an event of code modification (including addition) in Code Repository 102 (or IDE in Client Terminals 101), an event of source control action, an event of integrated development environment (IDE) action, or manually invoked by Client Terminals 101. Then, as shown in block 202, input data from one or more data sources related to a software program can be retrieved. By way of example, as part of the input data, the source code of the software, or of a specific software module of the software can be fetched. A list of behaviors characterizing the software program can be mapped by the Software Behavior Mapping module 104 based on the input data (which can be performed, e.g., by code text analysis, running the code, analyzing corresponding inputs and outputs, code tracing, etc.). For instance, the data sources can comprise at least one of: inputs and outputs of a sequence of actions in the software program, software documentation, data statically extracted from the source code, and runtime data collected during execution of the software program and representative of internal workings of the software program. Optionally, the mapped behaviors can be then stored in Property DB 105 as illustrated in block 203.

In some embodiments, as shown in block 204, optionally, these behaviors can be analyzed by the Behavior Analysis module 106 in various ways in order to reflect additional information about the behaviors (for example, the behaviors estimated correctness and/or the behaviors' corresponding tests' code coverage, etc.).

Then as shown in block 205, the list of behaviors, which can be extracted (e.g., by the Behavior Analysis module 106) in some cases as concise unique descriptors depicting a code behavior, can be transcoded/translated into corresponding natural language description(s) (NLD) by the Natural Language Generator 107. It is to be noted that in some cases each behavior can be transcoded into its own NLD. The list of behaviors would thus each has its corresponding NLD.

Optionally, property information, such as processed behaviors with their added information (Le., the results of their analysis such as traits and their natural language description) can be inserted into the Information DB 109 in 206. Such information, or part thereof, can now be presented to the user for inspection. Optionally, in block 207, the user can inspect, via UI 110, natural language description of the collection of behaviors, and can validate if an individual behavior fits the designed/intended behavior. If not, the system may provide recommendations and/or alerts to the user. The user can iteratively update the software module, and interact with system 103 via the UI until the mapped behavior is substantially identical to the designed behavior. Optionally, in block 208, the user can interact with the UI to generate corresponding tests that can be used for regression analysis. The user can also select what types and which tests to perform.

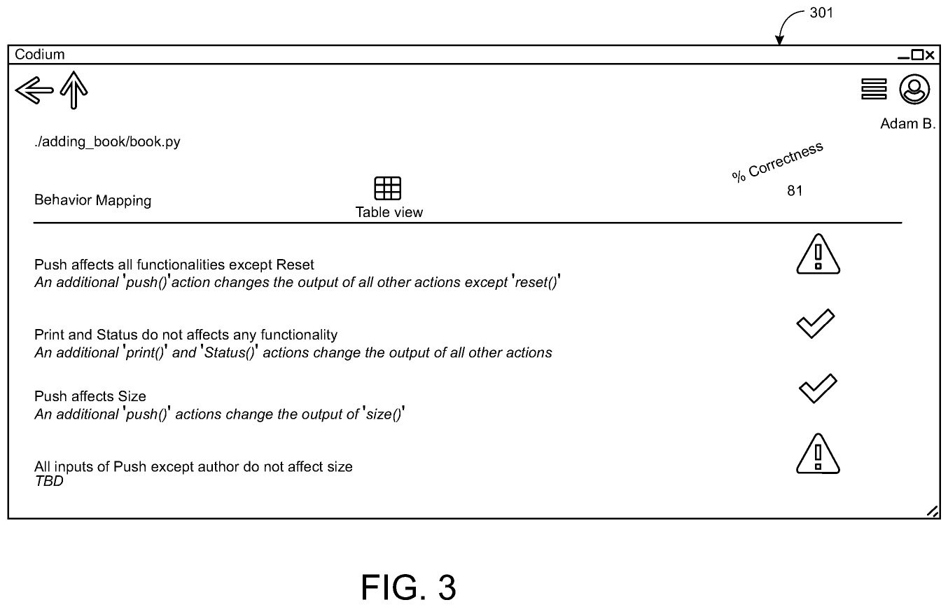

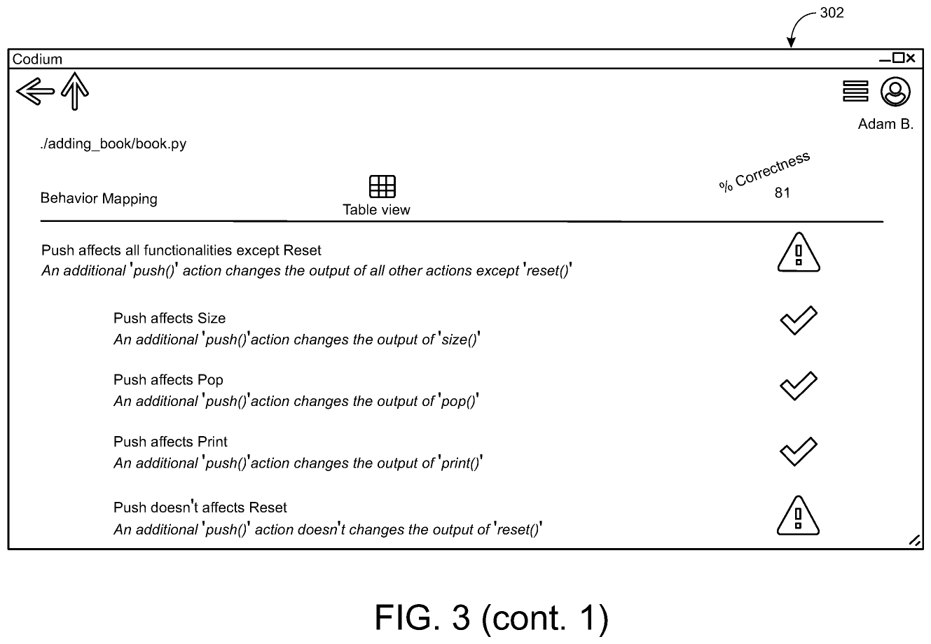

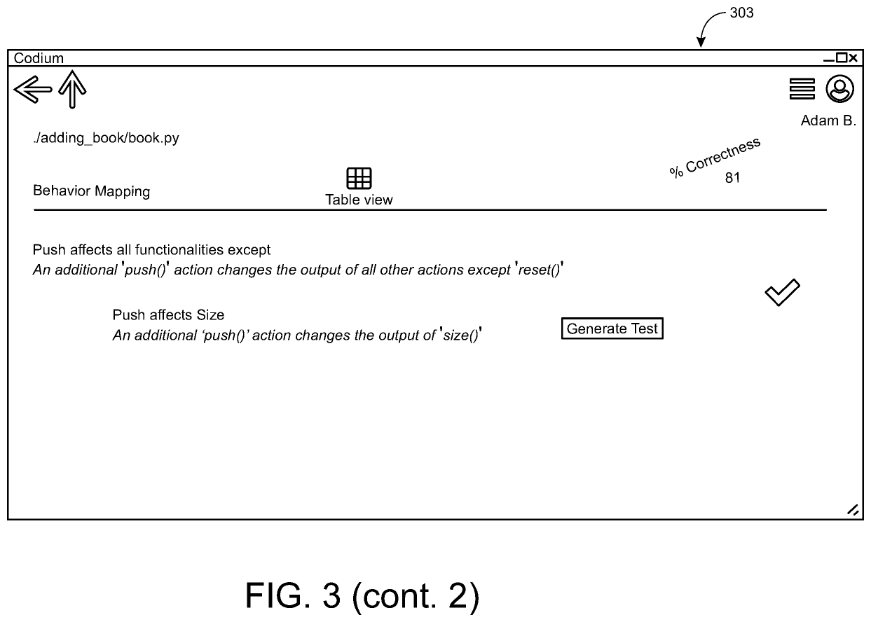

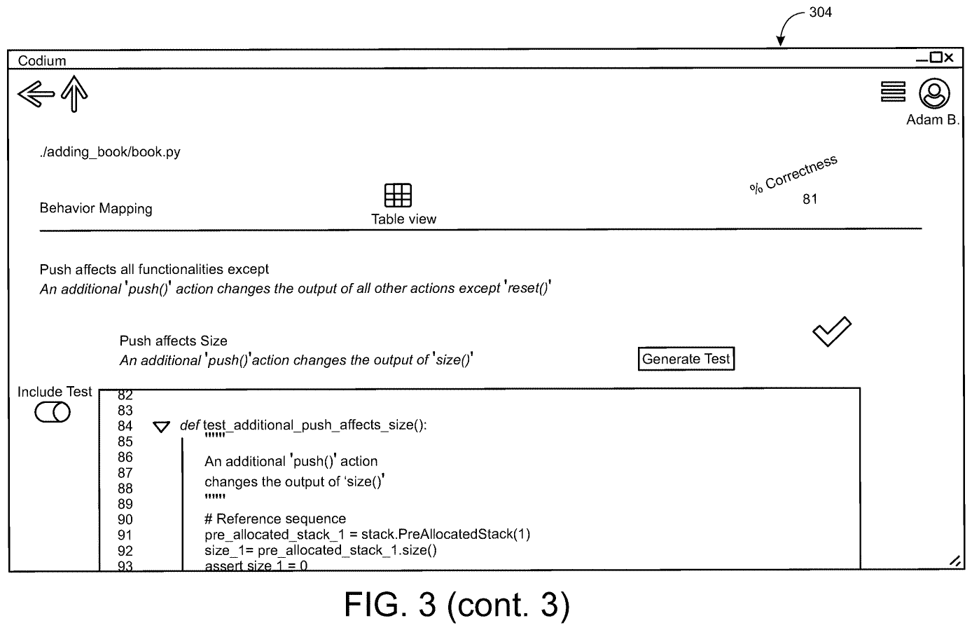

Referring now to the drawings, FIG. 3 is an exemplary user interface (UD) of an application of software behavior mapping and analysis in accordance with certain embodiments of the presently disclosed subject matter. First, as shown in the UI 301, once System 103 has finished the behavior mapping as described in 202, as well as the behavior analysis in 204 and the natural language transcoding in 205, it can now present the user with a list of behaviors the user can review and compare to its original intent. Each title and subtitle in 301 represents a behavior description in natural language, where the title is a more abstract representation and the subtitle is more specific. Potentially, for each behavior in 301, there can be a corresponding further analysis in the form of an alert, a score, or any other suitable forms, that can help the user notice which areas in the behavior mapping demand more careful inspection. By way of example, as exemplified in the column of correctness score, an overcall correctness score of 81 is estimated, taking into consideration all mapped behaviors. Specific icons are used for notifying healthy (illustrated by a click mark) or suspicious (illustrated by a warning mark, such as an exclamation mark) status for respective behaviors.

As can be seen in UI 301, each behavior is formulated in natural language which is transcoded by the Natural Language Generator 107. Optionally, in some cases, certain behaviors can be presented to the user in a hierarchical view, where each behavior can be inspected and drilled down to expose the underlying behaviors (i.e., sub-behaviors). As shown in UI 302, the behavior “push affects all functionalities except reset” can be drilled down to four sub-behaviors as listed under the general behavior. Again, each sub-behavior can be accompanied by a corresponding analysis, such as the correctness score. It can be appreciated that other visual representation techniques can be applied in addition to or in lieu of the exemplified hierarchical view, in order to aid the user to inspect the overall behavior of the code (for example, a grid view, sorted according to some criteria, etc.).

As further shown in UI 303 and 304, in some embodiments, for each behavior or sub-behavior, the user can be presented with (or actively request to generate, such as clicking the button “Generate Test” as illustrated in UI 303) a test or tests (either property-based or example-based) that validate the behavior under examination, such as the test presented in UI 304. In some cases, the user can decide whether to include this test or tests in the test suite, by clicking the option of “Include Test” as illustrated in UI 304. In some cases, the tests can be generated as a minimal representation of the behavior, such that the conciseness allows the user to easily understand the tests and the corresponding behavior.

For example, when a user is presented with the UI 301, the user may notice that the overall correctness score is not perfect. The user in this case may need to review the high-level behaviors, and look for a recommendation as where to further investigate. The user notices a suspicious high-level behavior (marked with an exclamation mark): “Push effects all functionalities except Reset”. When the user clicks on this high-level behavior, he/she can review the sub-behaviors as shown in UI 302. The hierarchical view shown in UI 302 shows that the suspicious behavior is attributed to the sub-behavior “Push doesn't affect Reset” (marked with an exclamation mark). The user in this case may agree with the system and look for the reason that this sub-behavior exists, contrary to what the design or the intent was.

In an alternative use case example, the user may choose to review the behaviors and select a subset of behaviors for which tests should be generated. This use case is presented in 303, where, as shown, the user has selected the sub-behavior “Push affects Size” which the user believes is an important behavior to keep and monitor. The user clicks the “Generate Test” button and a test is generated as seen in 304. The generated test can by itself help the investigation process in use cases like the former (e.g., having a minimal example, that surfaces the behavior, can be very helpful for a developer in order to reproduce the behavior). Alternatively, the generated test (in this case, an example-based test) can be used for embedding regression tests within the CI/CD processes. Tests can always be chosen to be included or removed from the test suite according to needs or other considerations such as, e.g., suite running time vs, test code coverage.

FIG. 4 is a generalized block diagram of software version comparison using software behavior mapping and analysis in accordance with certain embodiments of the presently disclosed subject matter. This diagram depicts how behavior mapping can be used to generate example-based and/or property-based testing. It also shows how different types of tests and properties can be used to validate new code versions compared with previous versions. As shown, original code 401 can be automatically analyzed by System 103 to create code behaviors and natural language description of code behaviors 402. Code behaviors and its NLD 402 can be used to automatically generate property-based testing 403 and example-based testing 404.

The aforementioned tests can, and usually are, manually written by the developers. Whenever a new version of the code is written, hence creating a modified code 405, the modified code 405 can be automatically analyzed by System 103 to create modified code behaviors and natural language description of code behaviors 406. The need arises to compare the behaviors between two versions (given that the code functionality itself should not have changed). Presently, the modus operandi to assure the code has not changed its behavior is to run the tests (property-based testing 403 and/or example-based testing 404 for the original code 401, and property-based testing 407 and/or example-based testing 408 for the original code 405) and confirm that they pass an assertion in the tests. In some embodiments, the comparison can also be done on the behavior level by comparing the code behaviors (and its corresponding NLD) 402 and 406 of the original code 401 and the modified code 405, for example, by a lexicographic distance. This comparison, due to its abstract nature, which is implementation independent, is less prone to break in the case of changing implementation details, while keeping the behavior intact.

In some embodiments, there is proposed a method of testing changes between different versions of a software program, comprising: retrieving a first version and a second version of the software program; mapping a first list of behaviors characterizing the first version and a second list of behaviors characterizing the second version; comparing the first list and second list of behaviors to identify one or more behaviors that have changed between the first and second versions; and presenting to a user the one or more behaviors, thereby allowing the user to decide whether to accept, reject, or fix the one or more behaviors.

This can also be referred to as testless testing. For any code change, the system can map behaviors of the code, both before and after the change. The system can compare the behaviors and find behaviors that have changed as a result of the code change (including any changes where a behavior did not exist before and exists afterwards, or vice versa). The system can present the user with the changed behaviors, so the user will be able to decide whether the change to behavior should be accepted, or whether the code change is incorrect and should be fixed. This has a similar effect to that of standard tests. However, with standard tests, the developer creates and maintains the tests, and then checks whether these tests pass or fail as code changes. With testless testing, the developer gets the same information, whether the behavior has changed, without the necessity to write or maintain the tests. They only need to approve changes to behaviors that are associated with the current code change.

Testless testing can surface changes to behaviors, both for individual examples and for properties. Testless testing can use shrinking of inputs related to properties, as shrinking provides smaller and simpler inputs, which are more easy-to-understand to the user.

In addition, testless testing has one or more of the following advantages compared to manual writing of tests: i) it reduces the efforts needed to verify correctness as code changes; ii) it makes the verification more comprehensive, as many of the covered behaviors would have not been covered by a manual test; iii) it is independent of developer efforts, in other words it is also independent of developers' goodwill, capabilities, and time pressure; and iv) verification will typically be more general, because it tends to focus on properties, and not on individual examples. Tests that verify properties are less likely to “break for the wrong reason” (i.e., fail because of a change to implementation details rather than real behavior change, thus demanding the developer's attention without actually protecting the developer from bugs).

It is to be noted that examples illustrated in the present disclosure are illustrated for exemplary purposes, and should not be regarded as limiting the present disclosure in any way. Other appropriate examples/implementations can be used in addition to, or in lieu of the above.

It is to be understood that the present disclosure is not limited in its application to the details set forth in the description contained herein or illustrated in the drawings.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1-29. (canceled)

30. A computerized method of software behavior analysis, the method comprising:
retrieving input data from one or more data sources related to a software program;
mapping a list of behaviors characterizing the software program based on the input data; and
transcoding the list of behaviors to corresponding natural language description (NLD) and presenting the NLD to a user on a graphic user interface (GUI).

31. The method of claim 30, wherein the one or more data sources are retrieved in response to an invocation by at least one of: an event of code completion, an event of code modification, an event of manual invocation by a client terminal, an event of source control action, and an event of integrated development environment (IDE) action.

32. The method of claim 30, wherein each behavior in the list of behaviors is an internal behavior or an external behavior which is property-based or example-based.

33. The method of claim 30, wherein the one or more data sources comprise at least one of: inputs and outputs of a sequence of actions in the software program, software documentation, data statically extracted from source code, and runtime data collected during execution of the software program and representative of internal workings of the software program.

34. The method of claim 30, further comprising analyzing the list of behaviors to obtain at least one trait of at least one of the behaviors.

35. The method of claim 34, wherein the at least one trait is selected from a group comprising: estimated correctness, and code coverage of the behaviors.

36. The method of claim 30, wherein the transcoding is performed by using a machine learning (ML) model capable of learning relationships between the list of behaviors and corresponding natural language description, in order to convert therebetween.

37. The method of claim 30, wherein the transcoding is performed by using a series of ML models that are, respectively or in combination, configured to perform at least some of the following: classifying the list of behaviors to one or more types, selecting templates that are closely related to the one or more types, and filling in the templates, thereby resulting in the corresponding natural language description.

38. The method of claim 30, wherein the transcoding comprises:
obtaining a dataset comprising a plurality of samples, each sample represented by a tuple constituted by code, code behavior, and NLD of the code;
providing an input comprising source code of the software program from the input data, and the list of behaviors, and searching in the dataset for one or more candidate samples based on a similarity metric between the input, and the code and the code behavior of the tuple of each sample in the plurality of samples; and
using the one or more candidate samples as templates for generating the NLD of the list of behaviors using a large language model (LLM).

39. The method of claim 38, wherein the using comprises providing the one or more candidate samples as one or more input examples to the LLM to enable the LLM to learn from the input examples using in-context learning (ICL), thereby obtaining, as output of the LLM, the NLD of the list of behaviors.

40. The method of claim 38, wherein the using comprises extracting a NLD template from the one or more candidate samples and using the LLM to fill in the NLD template, thereby obtaining the NLD of the list of behaviors.

41. The method of claim 40, wherein the NLD template is represented as a text placeholder characterized by one or more parameters extracted from the one or more candidate samples.

42. The method of claim 30, wherein the NLD includes a visual representation of a diagram representing architecture of a corresponding behavior in the list of behaviors.

43. The method of claim 30, further comprising manipulating the list of behaviors by at least one of: filtering, ordering, and grouping the list of behaviors.

44. The method of claim 43, wherein the manipulating comprises: consolidating the list of behaviors to a group of high-level behaviors based on at least one trait, wherein each high-level behavior is associated with its subsidiary behaviors, and presenting the natural language descriptions of each high-level behavior and subsidiary behaviors associated therewith on the GUI in a hierarchical view.

45. The method of claim 30, further comprising enabling the user to manipulate at least part of the natural language descriptions including at least one of the following: accepting, rejecting, adding, or amending a natural language description of a desired behavior, thereby indicating a portion in source code of the software program that needs to be adjusted accordingly.

46. The method claim 30, further comprising inspecting the one or more behaviors with respect to one or more designed behaviors to verify original intent thereof.

47. The method of claim 30, further comprising automatically generating one or more tests for each behavior from a subset of behaviors selected from the list of behaviors.

48. The method of claim 47, wherein the subset of behaviors is selected based on the at least one trait or a user's decision.

49. The method of claim 47, wherein the one or more tests are property-based and/or example-based.

50. The method of claim 47, wherein the generating comprises searching for a minimal representation of the one or more tests for at least one behavior of the subset of behaviors.

51. The method of claim 30, wherein the retrieving and mapping are performed for a first version of the software program and a second version of the software program, giving rise to a first list of behaviors and a second list of behaviors, wherein the method further comprises comparing the first and second lists of behaviors for validating changes between software versions.

52. The method of claim 51, wherein the first and second lists of behaviors are transcoded into corresponding first and second natural language descriptions, and wherein the comparing comprises comparing the first and second natural language descriptions.

53. The method of claim 52, wherein the comparison of the first and second natural language descriptions uses a machine learning model capable of performing matching and scoring matches of natural language descriptions.

54. A computerized system of software behavior analysis, the system comprising a processing and memory circuitry (PMC) configured to:
retrieve input data from one or more data sources related to a software program;
map a list of behaviors characterizing the software program based on the input data; and
transcode the list of behaviors to corresponding natural language description (NLD) and presenting the NLD to a user on a graphic user interface (GUI).

55. A non-transitory computer readable storage medium tangibly embodying a program of instructions that, when executed by a computer, cause the computer to perform the method steps of a method of software behavior analysis, comprising:
retrieving input data from one or more data sources related to a software program;
mapping a list of behaviors characterizing the software program based on the input data; and
transcoding the list of behaviors to corresponding natural language description (NLD) and presenting the NLD to a user on a graphic user interface (GUI).
